(19) United States
(12) Patent Application Publication
(10) Pub. No.: US 2019/0311158 A1
(43) Pub. Date: Oct. 10, 2019

(54) COMPUTER ANTI-THEFT DEVICE

(71) Applicant: EVGA CORPORATION, New Taipei City (TW)

(72) Inventor: Tai-Sheng Han, New Taipei City (TW)

(21) Appl. No.: 15/949,054

(22) Filed: Apr. 9, 2018

(51) Int. Cl. G06F 21/88

(52) U.S. Cl. CPC G06F 21/88; E05B 73/0005

(57) ABSTRACT

The computer anti-theft device includes a main board, a component detachably mounted on the main board, and an anchor element fixedly mounted on the main board. The anchor element has a first fastener, and the component has a second fastener. A cable element has its two ends connected with the first and second fasteners, respectively. Through the above structure, the cable element and the anchor element jointly lock the various components inside the computer to the main board. As such, these components are prevented from being swapped or removed by unauthorized users, thereby achieving the anti-theft effect.

### BACKGROUND OF THE INVENTION

### (a) Technical Field of the Invention

The present invention is generally related to anti-theft devices, and more particular to a computer anti-theft device locking various hardware components on the computer's main board.

### (b) Description of the Prior Art

Computers have become indispensable appliances for every corporation and household. They are applied to document processing, game playing, movie watching, or even shopping. These applications are all familiar to ordinary users. However, it is a different story for hardware maintenance.

For some crooked hobbyist, they take advantage of most people's inexperience with the computer hardware, and steal vital and expensive components inside other people's computers, or replace them with cheap and inexpensive ones. Some even purchase high-end computers from stores, swap out the expensive parts, and return the computers for refund or repair. Therefore, how to prevent this kind of theft becomes a major issue with the computer retailers.

### SUMMARY OF THE INVENTION

A major objective of the present invention is to provide a cable element and an anchor element that jointly lock the various components inside the computer to the computer's main board. As such, these components are prevented from being swapped or removed by unauthorized users, thereby achieving the anti-theft effect.

To achieve the objective, the computer anti-theft device includes a main board, at least a component detachably mounted on the main board having a second fastener, at least an anchor element fixedly mounted on the main board, at least a first fastener configured on an anchor element, and at least a cable element whose two ends connect a first fastener and a second fastener, respectively.

Through the above structure, the component is first mounted on the main board and the anchor element is fixed on the main board. Then, the cable element has its two ends connected with the first fastener on the anchor element and the second fastener on the component. Therefore, the cable element and the anchor element jointly lock the component to the computer's main board, and the component is prevented from being swapped or removed by unauthorized users, thereby achieving the anti-theft effect.

Through the present invention, the computer retailers' problem of crooked buyers removing or replacing hardware components, and then asking for refund or repair is avoided.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a computer anti-theft device according an embodiment of the present invention.

FIG. 2 is a perspective breakdown diagram showing the computer anti-theft device of FIG. 1.

FIG. 3 is a schematic diagram showing a scenario of the computer anti-theft device of FIG. 1.

FIG. 4 is a perspective diagram showing a computer anti-theft device according another embodiment of the present invention.

FIG. 5 is a perspective diagram showing a scenario of the computer anti-theft device of FIG. 4.

FIG. 6 is a perspective diagram showing a computer anti-theft device according yet another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

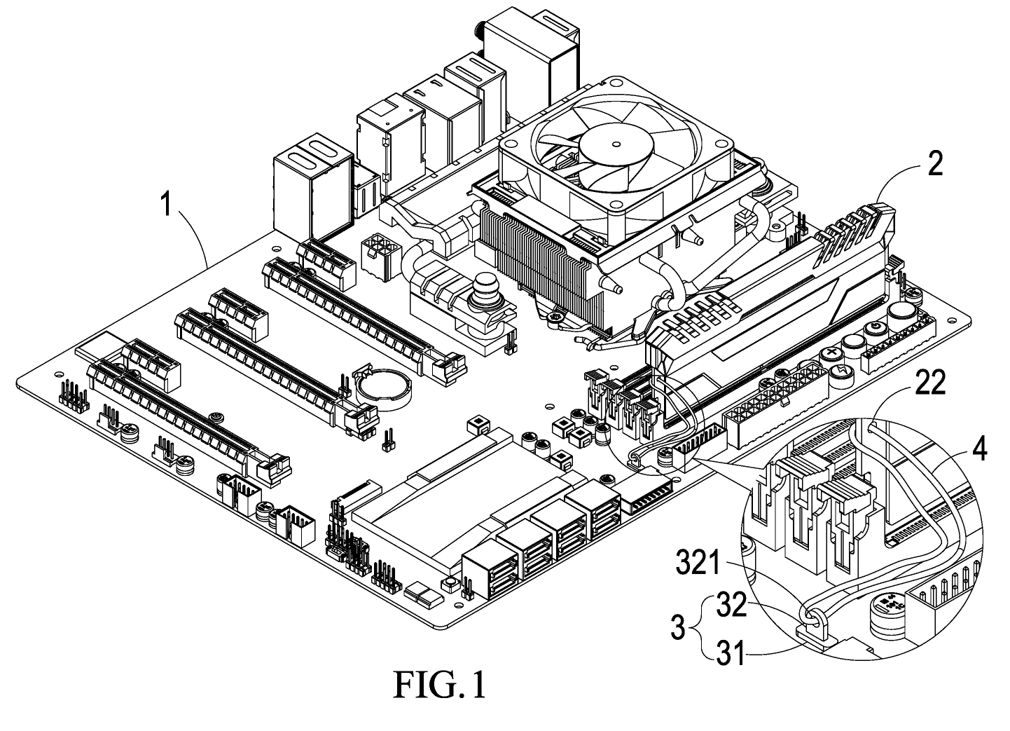

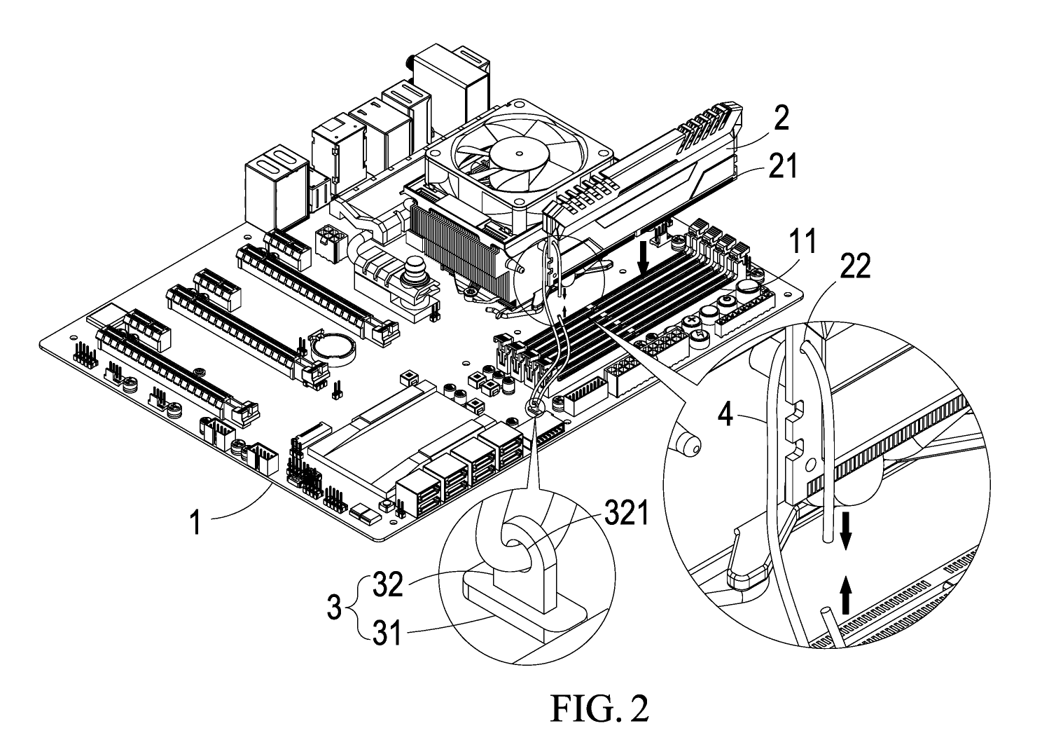

As shown in FIGS. 1 and 2, a computer anti-theft device according an embodiment of the present invention includes a main board 1, at least a component 2, at least an anchor element 3, and a cable element 4. The main board 1 has a socket 11 and the component 2 has a corresponding plugging piece 21 for detachably plugging into the socket 11. The component 2 is a hardware parts such as a central processing unit (CPU), a graphics card, etc., that is installed on the main board 1. The anchor element 3 includes a base 31 for fixedly mounting the anchor element 3 onto the main board 1 and a piece 32 on a top side of the base 31. The piece 32 has a first fastener 321. The component 2 also has a second fastener 22. The cable element 4 joins the first and second fasteners 321 and 22. In the present embodiment, the first fastener 321 and the second fastener 22 are through openings on the anchor element 3 and the component 2, respectively, and the cable element 4 is a flexible cable miming through the first and second fasteners 321 and 22 in a loop.

As described above, the computer anti-theft device prevents detachable component 2 from being stolen by linking it to the fixed anchor element 3 through the cable element 4.

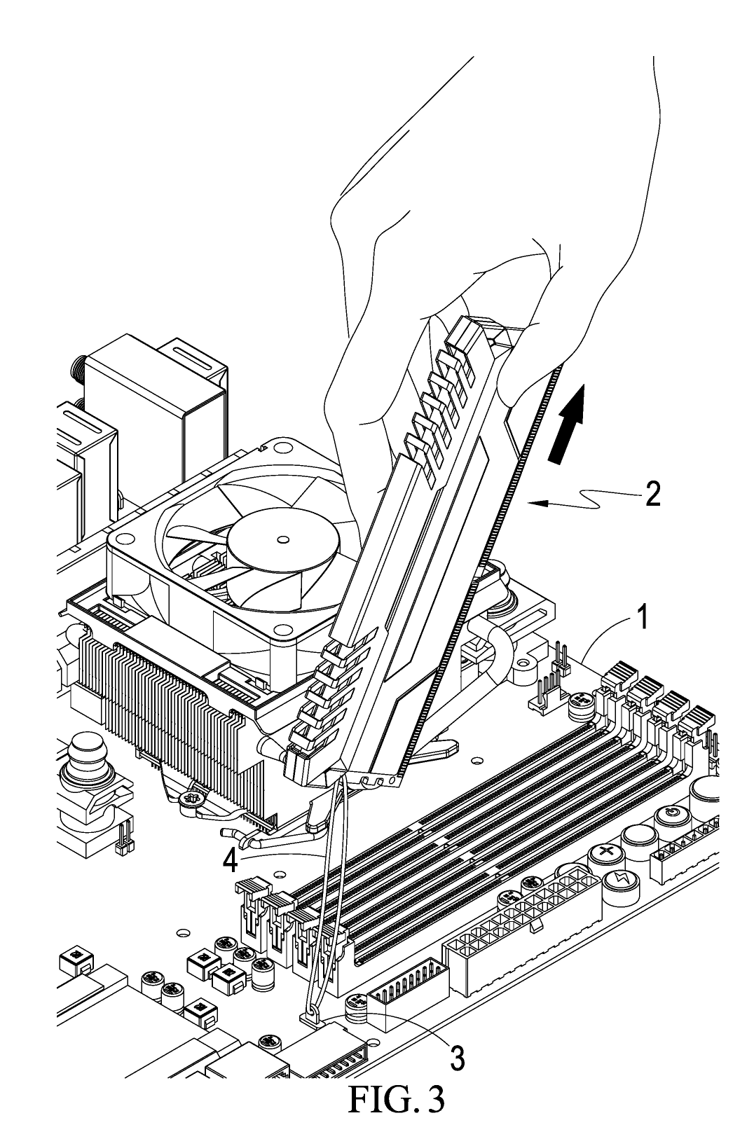

As shown in FIGS. 1 to 3, the component 2 is mounted to the main board 1 by plugging its plugging piece 21 into the socket 11. The plugging piece 21 may have golden fingers on it. The base 31 of the anchor element 3 may be adhered to the main board 1. The cable element 4 has its two ends run through the first and second fasteners 321 and 22, and joined end-to-end together by, for example, adhesive. The component 2 therefor is locked to the anchor element 3 and the main board 1 as well. The component 2 is as such prevented from being removed or replaced.

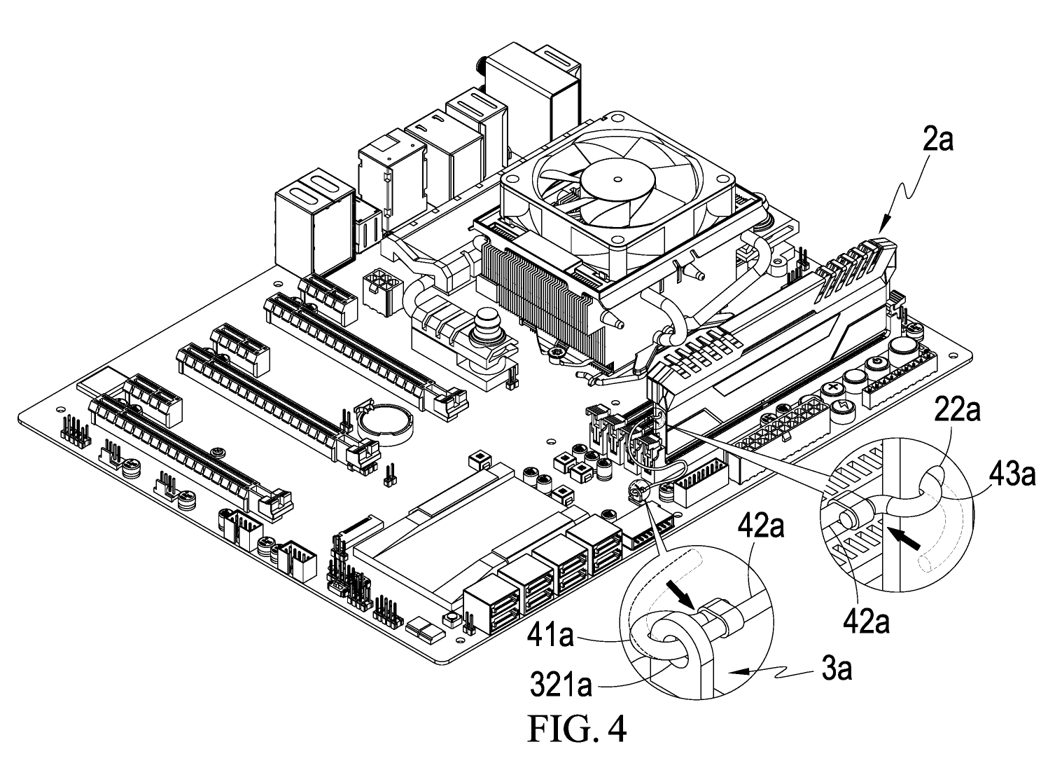

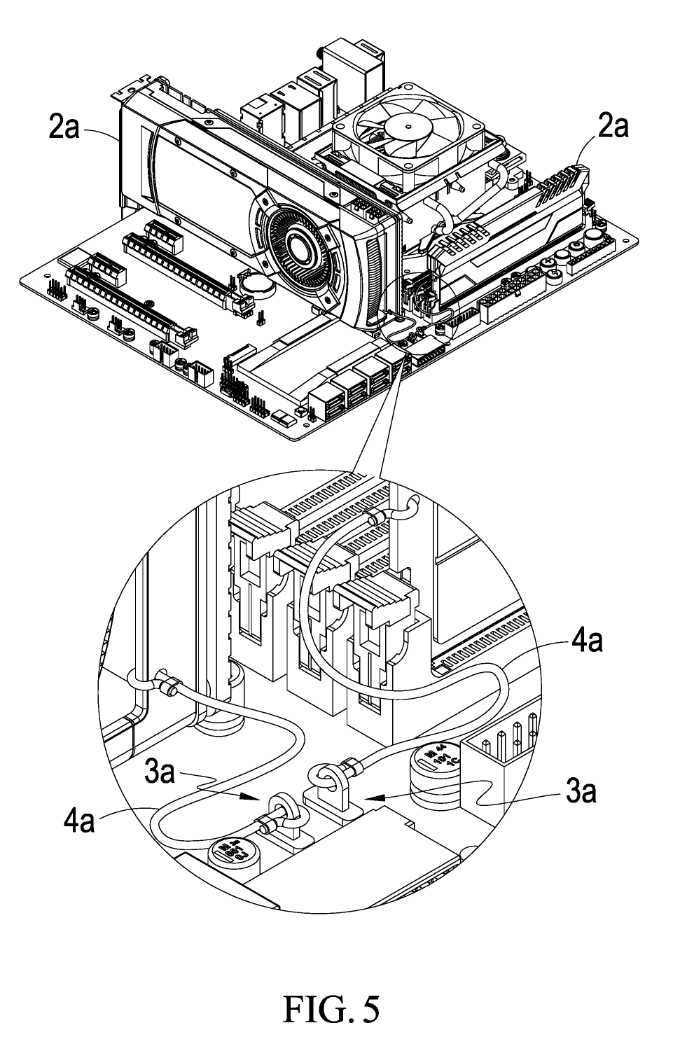

As shown in FIGS. 4 and 5, another embodiment of the present invention differs from the previous embodiment in that the cable element 4a includes a main section 42a, a first hook section 41a at a first end of the main section 42a, and a second hook section 43a at a second end of the main section 42a. The first hook section 41a is locked to the first fastener 321a on the anchor element 3a, and the second hook section 43a is locked to the second fastener 22a on the components 2a. In the present embodiment, the cable element 4a is an integrally formed metallic cable. The first and second hook sections 41a and 43a are the two ends of the metallic cable that are run through the first and second fasteners 321a and 22a, and then fixedly bound to the main section 42a. The component 2a is as such locked to the anchor element 3a.

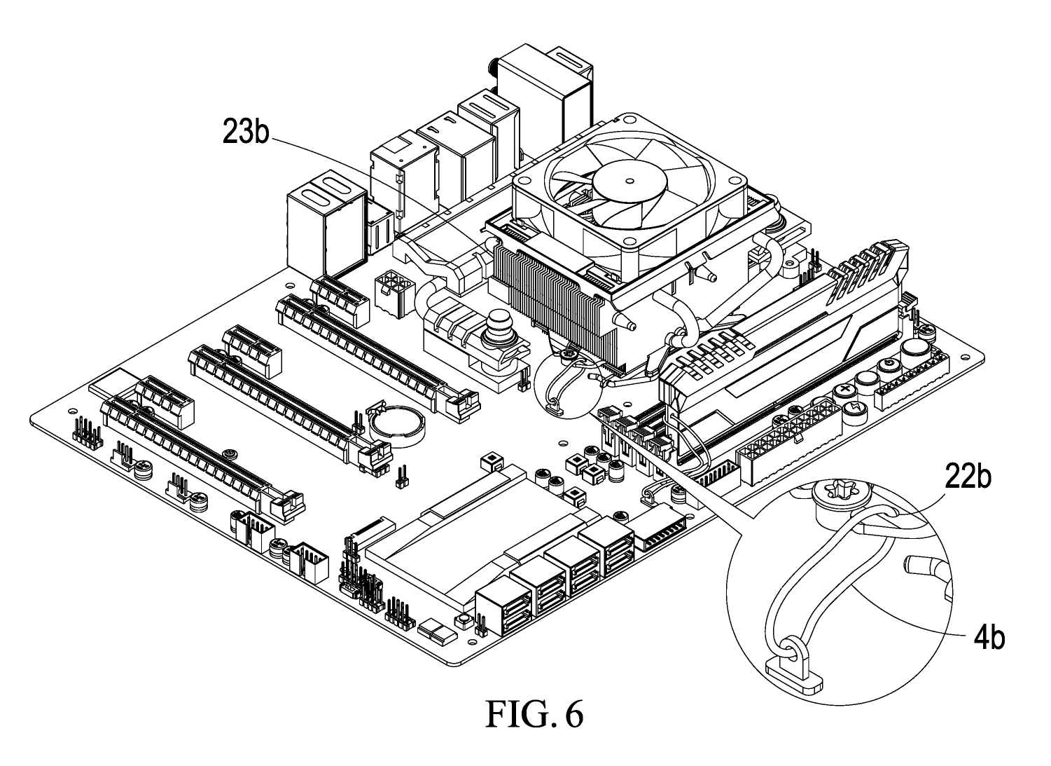

As shown in FIG. 6, yet another embodiment of anti-theft device differs from the previous embodiments as follows. Due to that the second fastener 22b cannot be configured on some part such as the CPU, the second fastener 22b is instead configured on the heat dissipation assembly 23b. Then the cable element 4b locks the second fastener 22b. If the CPU is to be removed, the heat dissipation assembly 23b has to be removed first. The present embodiment as such achieves the same protection to the CPU.

The gist of the present invention, as described above, is, by fixing the anchor element 3 on the main board 1 and using a cable element 4 to connect the component 2 to the anchor element 3. The component 2 is therefore locked to the main board 1, and the anti-theft effect is attained.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A computer anti-theft device, comprising:
a main board;
at least a component detachably mounted on the main board having a second fastener;
at least an anchor element fixedly mounted on the main board;
at least a first fastener configured on an anchor element; and
at least a cable element whose two ends connect a first fastener and a second fastener, respectively.

2. The computer anti-theft device according to claim 1, wherein the main board has a socket for mounting the component.

3. The computer anti-theft device according to claim 2, wherein the component has a plugging piece for plugging into the socket.

4. The computer anti-theft device according to claim 1, wherein the cable element is a flexible cable.

5. The computer anti-theft device according to claim 1, wherein the cable element comprises a first hook section at a first end for connecting the anchor element.

6. The computer anti-theft device according to claim 5, wherein the cable element further comprises a second hook section at a second end for connecting the component.

7. The computer anti-theft device according to claim 6, wherein the cable element further comprises a main section between the first and second hook sections.

8. The computer anti-theft device according to claim 1, wherein the anchor element comprises a base and a piece on a top side of the base.

9. The computer anti-theft device according to claim 8, wherein the base is for fixedly mounting the anchor element onto the main board;
and the first fastener is on the piece for the connection of the cable element.

10. The computer anti-theft device according to claim 1, wherein the first and second fasteners are through openings.
